(19) United States
(12) Patent Application Publication
(10) Pub. No.: US 2013/0129330 A1
(43) Pub. Date: May 23, 2013

(54) FLUID RESERVOIR HAVING A HEATING RESERVE BOWL

(71) Applicants: Rodolphe Emaille, La Cote Saint Andre (FR); Philippe Chaffraix, Nimes (FR)

(72) Inventors: Rodolphe Emaille, La Cote Saint Andre (FR); Philippe Chaffraix, Nimes (FR)

(73) Assignee: MGI COUTIER, Champfromier (FR)

(21) Appl. No.: 13/696,126

(22) PCT Filed: Sep. 8, 2010
(86) PCT No.: PCT/FR2010/051867

§ 371 Date: Jan. 15, 2013

(30) Foreign Application Priority Data
May 3, 2010 (FR) 10/53396

(51) Int. Cl. F24H 1/18; F01N 3/20

(52) U.S. Cl. CPC F01N 3/206; B67D 7/82
USPC 392/441; 219/441

(57) ABSTRACT

The invention relates in particular to a reservoir for a urea-based reducing agent, with an integrated electric heating element, usable on a heat engine vehicle for pollution control. The heating element (10) provided to thaw the reducing agent (6) is placed inside a cavity (16) delimited by a bowl (13), itself placed inside the reservoir (1). The cavity (16) of the bowl (13) communicates with the inner volume (5) of the reservoir by a valve (20). A suction pipe (12) for the reducing agent is submerged in the cavity (16) of the bowl (13), the starting point (18) of said pipe being situated near the heating element (10). Operation is thus guaranteed when the vehicle is under sloping and inclined conditions, and also in case of freeze.

### TECHNICAL FIELD

The present invention relates to a fluid reservoir, and more particularly a reservoir adapted for a fluid likely to freeze or the viscosity of which varies greatly depending on the temperature, the reservoir being equipped to that end with an integrated electrical heating element, able to at least partially thaw the fluid contained in the reservoir. This invention is applicable, inter alia, to a reducing agent reservoir, in particular a urea-based reducing agent, usable on a heat engine vehicle for pollution control purposes. Still more particularly, the invention relates to such a reservoir that is provided with a heated holding bowl, from which the fluid is withdrawn, such as a reducing agent, contained in the reservoir and to be withdrawn to be used.

### BRIEF DESCRIPTION OF RELATED ART

To comply with pollution standards, motor vehicles must have connected pollution control device that are increasingly complex, the chemistry of pollution control requiring either catalysts, or oxidizing agents or reducing agents that are added, in particular in the exhaust line, for pollution control.

Concerning pollution control for motor vehicles with diesel engines, the standards require builders to equip the exhaust systems with a catalytic converter, provided to reduce the nitrogen oxides through ammonia. However, ammonia being a toxic product, pollution control is done by using urea, dissolved in water in a proportion of 33% for example, which is transformed into ammonia by thermo-hydrolysis in the exhaust system, only when it is used. This process is commonly called “SCR” (Selective Catalytic Reduction).

The proportioning of the urea must be adjusted to the needs created by the nitrogen oxide emissions, generated by the motor. To that end, the urea is stored in a reservoir, pressurized by a pump and distributed by an electromagnetic injector, the pump and the injector proportioning the quantity of urea taken from the reservoir and sent into the exhaust line, in connection with the operation of the motor, therefore with the nitrogen oxide emissions passing through the exhaust line.

In this type of pollution control installation, it is imperative to provide heating means, to resolve the problems of the urea or other reducing agent freezing, problems which can appear once the temperature is below −11° C. for certain reducing agents, or lower temperatures for other reducing agents.

Various solutions have already been proposed for heating the reducing agent, in order to be able to withdraw and distribute it irrespective of the temperature conditions. A first type of solution consists of making a reducing agent reservoir provided with an integrated electric heating element, able to at least partially thaw the reducing agent.

Among the existing solutions, one consists of a heating element using positive temperature coefficient (PTC) power thermistors, molded from a casting and placed in the bottom of the reservoir—see German patent application DE 10 2005 036 430 A1. Another solution, described in French patent application FR 2 918 968 A1, provides a heating element in the form of resistive tracks affixed on a flexible film or between two flexible films, placed inside the reservoir and resting in particular on the bottom of the reservoir.

Another requirement to be taken into account is to preserve the operation of the withdrawal system under sloping and inclined conditions, even with a nearly empty reservoir, without draining the system.

Among the existing solutions, known in particular is that described in French patent application FR 2 890 341 A1, where a connected pump fills a holding tank from which the primary pump withdraws fluid. The holding tank can be mounted inside the reservoir, in particular in the volume defined by the wall of a holding tank formed at the bottom of the reservoir.

All of these solutions remain fairly complex and expensive, and do not necessarily guarantee operation when the reducing agent level is low and the vehicle is in a sloping or inclined condition.

### BRIEF SUMMARY

The present invention aims to provide a simple solution to the problems described above.

To that end, the invention relates to a fluid reservoir, for example a reducing agent reservoir, in particular a urea-based agent, usable on a heat engine automobile for pollution control purposes, the reservoir being equipped with an integrated electric heating element, able to at least partially thaw the fluid such as reducing agent contained in the reservoir, wherein the heating element is placed inside a cavity defined by a bowl, the bowl being placed inside the reservoir, said cavity communicating with the inner volume of the reservoir via at least one valve, while a suction pipe of the fluid such as a reducing agent is submerged in the cavity delimited by the bowl, the starting point of the suction pipe being situated near the heating element.

Advantageously, the electric heating element is placed at the bottom of the bowl. The valve is for example a membrane valve, this valve also being placed advantageously in the bottom of the bowl.

This bowl can be made of stainless steel, for reasons of compatibility with the reducing agents usually used.

In one embodiment, in addition to the suction pipe for the reducing agent, a tube is also provided submerged in the cavity delimited by the bowl and conveying electric power supply leads of the heating element.

The suction pipe for the fluid such as a reducing agent, and the tube for conveying the electric power supply leads of the heating element, are also advantageously made from stainless steel, for the same reasons as the bowl itself.

Thus, the invention proposes a simple solution, with the use of a holding bowl for the fluid such as a reducing agent, not requiring a related pump while guaranteeing suitable operation even under sloping or inclined conditions, and also allowing operation at low temperatures owing to the heating element, carefully positioned inside the cavity delimited by the bowl. It will be noted that a temperature sensor, having a function for controlling the heating and thermal protection, can be associated with the heating element, this temperature sensor therefore also being located in the bottom region of the bowl. The combination of the bowl and the heating element offers the advantage that the thawed fluid is confined in the priority use area, where the fluid is suctioned, such that only the quantity of fluid strictly needed is thawed, for economical, fast, and completely controllable operation.

### BRIEF DESCRIPTION OF THE DRAWINGS

The invention will be better understood using the description that follows, in reference to the appended diagrammatic drawing showing, as an example, one embodiment of this fluid reservoir with a heated holding bowl.

FIG. 1 is a vertical cross-sectional view of a reducing agent reservoir with a heated holding bowl according to the present invention,

FIG. 2 shows an enlarged view, in vertical cross-section, of the detail of the bowl with the heating element,

FIGS. 3 and 4 are views similar to FIG. 2, illustrating the filling of the bowl and the operation of the valve,

FIGS. 5 and 6 are vertical cross-sectional views of the reservoir, illustrating its operation in the event the reducing agent freezes,

FIG. 7 illustrates the operation of the reservoir and in particular its bowl, under sloping or tilted conditions.

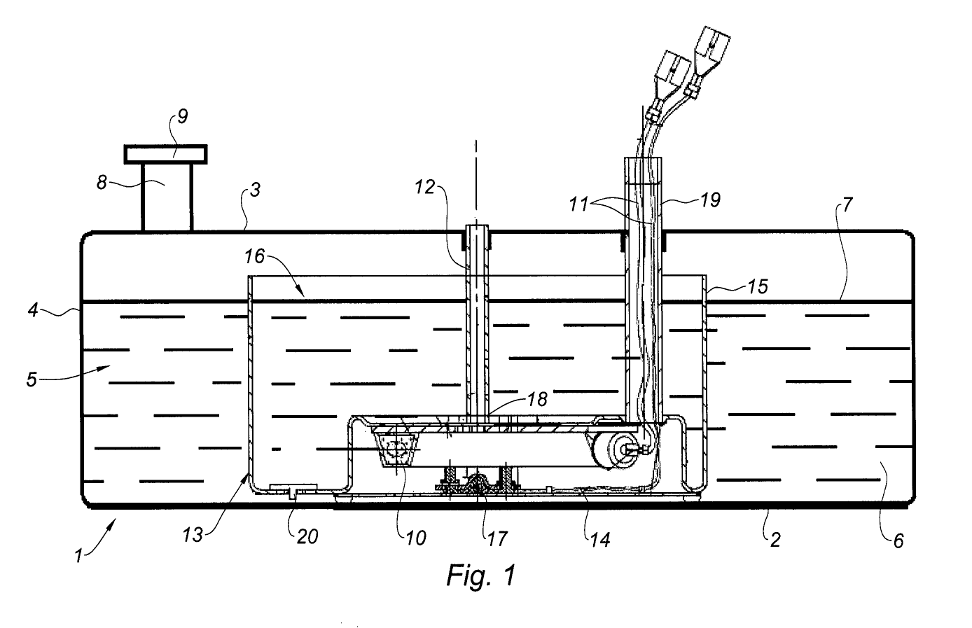

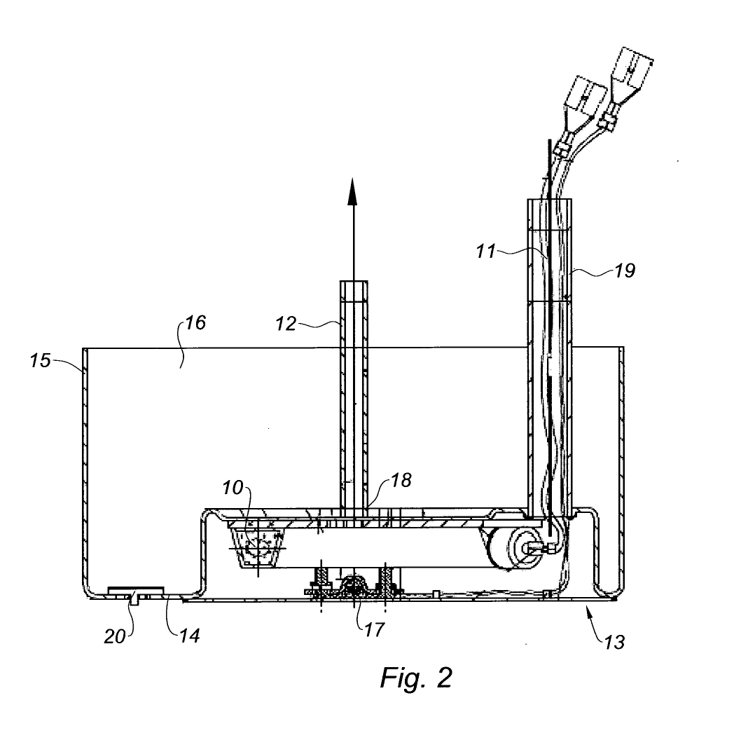

### DETAILED DESCRIPTION

In the drawing, reference 1 designates, in its entirety, a reducing agent reservoir, which comprises a lower wall 2, an upper wall 3 and a side wall 4, which delimit an interior volume 5 of said reservoir 1.

The reservoir 1 contains, during use, a certain quantity of reducing agent 6, the level of which is indicated in 7. A filling orifice 8, placed on the upper wall 3 and normally covered by a plug 9, makes it possible to introduce the reducing agent 6 into the reservoir 1.

In its lower portion, the reservoir 1 is equipped with a heating element 10 of the electric type, powered by electrical conductors 11. The heating element 10 is provided to at least partially thaw the reducing agent 6 in order to allow it to be withdrawn by a suction pipe 12, even at low temperatures. The suction pipe 12 is oriented towards a pump (not shown) using which the reducing agent 6 is withdrawn from the reservoir 1 and sent towards an injector, which distributes the reducing agent in the exhaust line of the concerned vehicle.

The reservoir 1 is equipped with a bowl 13 placed in the inner volume 5 thereof. The bowl 13 has a bottom 14 and a side wall 15, which delimit a cavity 16, this bottom 14 of the bowl 13 being situated slightly higher than the lower wall 2 of the reservoir 1. The bowl 13 is kept in the central region of the inner volume 5 of the reservoir 1 by fixing means, not shown. The heating element 10 is placed in the bottom 14 of the bowl 13, a temperature sensor 17 being associated with that heating element 10, with a dual function of controlling the heating and thermal protection.

The suction pipe 12 for the reducing agent 6 is submerged in the cavity 16 of the bowl 13, the starting point 18 of this suction pipe 12 being situated near the heating element 10.

A tube 19 is also submerged in the cavity 16 of the bowl 13, parallel to the suction pipe 12. The tube 19 serves to convey the electrical conductors 11 that power the heating element 10.

In the bottom 14 of the bowl 13 is a valve 20, in particular in the form of a membrane valve, able to create or interrupt communication between the cavity 16 of the bowl 13, on one hand, and the inner volume 5 of the reservoir 1, on the other hand.

The reducing agent 6 being urea-based, the bowl 13 can be made of stainless steel for compatibility reasons with said reducing agent. Likewise, the suction pipe 12 and the tube 19 for conveying the electrical conductors can be made from stainless steel. Other materials compatible with the reducing agent, and ensuring good heat transfer, can also be considered here.

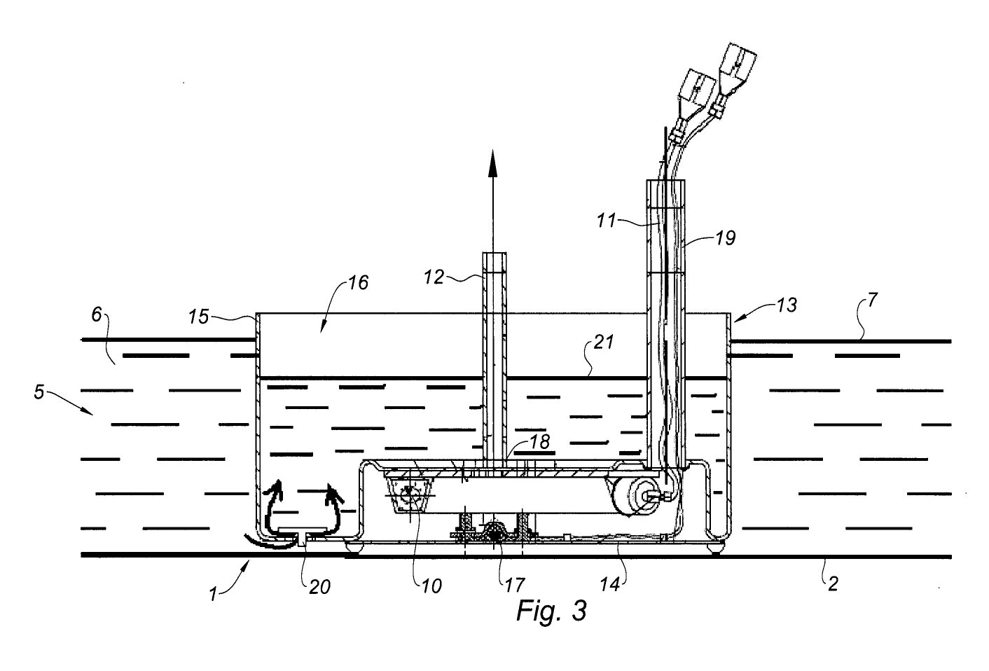

In reference more particularly to FIGS. 3 to 6, we will now describe the operation of the reservoir 1, under various conditions.

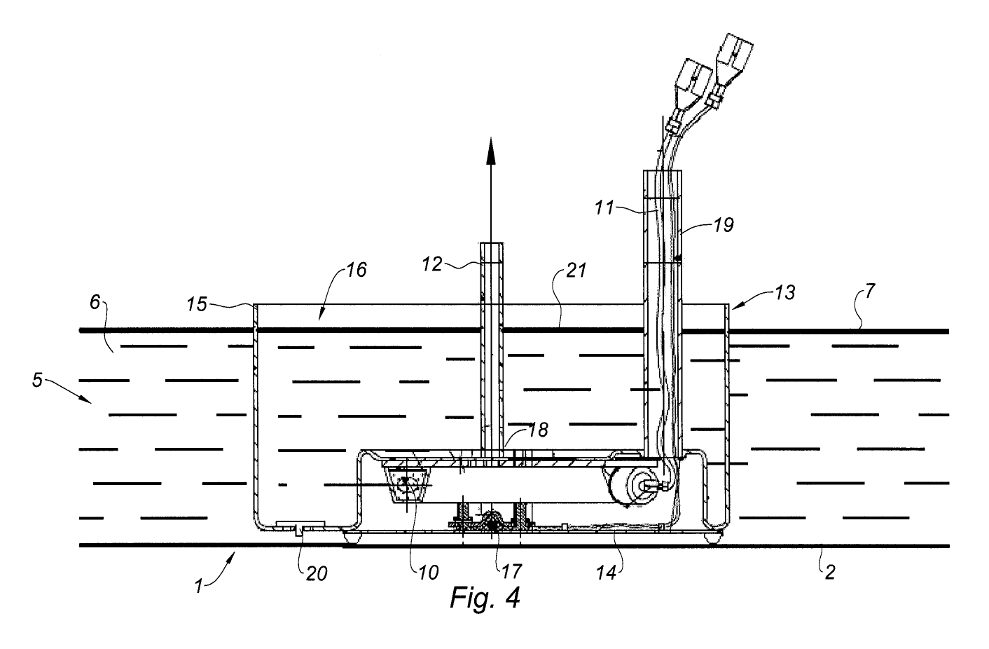

FIGS. 3 and 4 illustrate the operation to withdraw the reducing agent 6 when it is not frozen. If, at a given moment, the level 21 of the reducing agent in the cavity 16 of the bowl 13 is below the level 7 of that reducing agent in the rest of the reservoir 1, the valve 20 lifts under the hydrostatic pressure, and the reducing agent 6 thus penetrates the cavity 16 of the bowl 13, as indicated by the arrows F in FIG. 3, until the levels 21 and 7 are equalized between the inside and outside of the bowl 13; the valve 20 then closes (see FIG. 4).

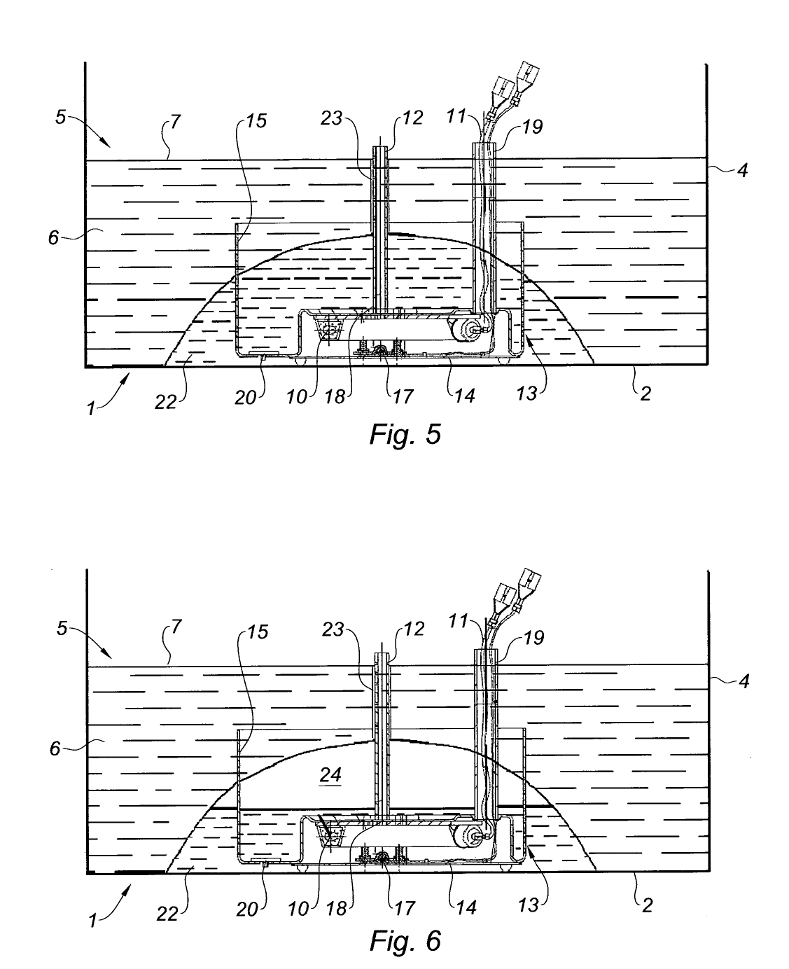

FIGS. 5 and 6 illustrate the operation of the reservoir 1 in the event the reducing agent 6 freezes, so at low temperatures. Initially, it is assumed that the reducing agent 6 is completely frozen.

The heating element 10 is then powered by the electrical conductors 11, and it thus causes a partial thawing of the reducing agent 6, inside the bowl 13 and also all around that bowl 13. In FIG. 5, the volume of thawed reducing agent is indicated in 22.

When the reducing agent must be withdrawn by the suction pipe 10, it is first the thawed reducing agent 22 inside the bowl 13 that is suctioned. The level of thawed reducing agent 22 will then gradually decrease in the bowl 13. Along the suction pipe 10 heated by thermal conduction, a cylindrical layer of thawed reducing agent 23 forms, thereby allowing outside air to enter the bowl 13 and refill the cavity 24 resulting from the pumping of the reducing agent.

The suctioning of the thawed reducing agent 22 continuing, the valve 20 allows the thawed reducing agent located outside the bowl 13 to enter (following the operation described above in reference to FIGS. 3 and 4), which extends the operating duration of the withdrawal system, before the system is drained.

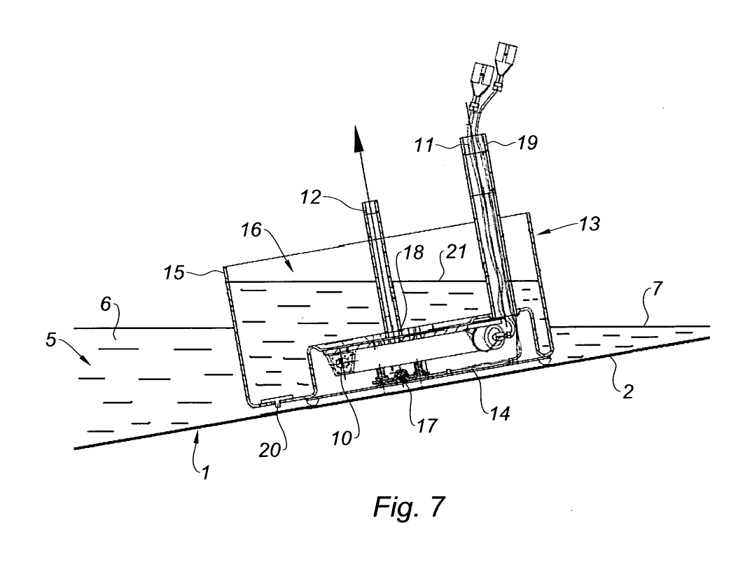

Lastly, FIG. 7 illustrates the operation when the automobile, and therefore the reservoir 1, is in a sloping or inclined state, and the level 7 of reducing agent 6 in the reservoir 1 is low, i.e. below the height of the bowl 13. Owing to the valve 20, the reducing agent 6 is kept in the bowl 13, which extends the operating duration of the withdrawal system under such conditions.

It would not be outside the scope of the invention, as defined in the appended claims, to:
alter the shape of the bowl,
make the bowl, as well as the suction pipe and the tube for conveying the electrical conductors, from any material compatible with the nature of the reducing agent,
equip the bowl with any type of heating element: CTP thermistor, ceramic resistor, etc.,
use any equivalent means, for example replacing the tube for conveying the electrical conductors with an electric cable,
add any accessories, for example providing a suction strainer upstream of the suction pipe and placed in the bowl,
fasten the bowl in the reservoir using any means,
use the invention for reservoirs of all shapes, able to contain a reducing agent of any nature, or another fluid likely to freeze or whereof the viscosity varies greatly as a function of the temperature, for example a windshield wiper fluid reservoir for a vehicle.

1. A fluid reservoir, for example a reducing agent reservoir, in particular a urea-based agent, usable on a heat engine automobile for pollution control purposes, the reservoir comprising:
an integrated electric heating element, able to at least partially thaw the fluid such as reducing agent contained in the reservoir,
wherein the heating element is placed inside a cavity delimited by a bowl,
the bowl being placed inside the reservoir,
said cavity communicating with an inner volume of the reservoir via at least one valve,
while a suction pipe of the fluid such as a reducing agent is submerged in the cavity delimited by the bowl, the starting point of the suction pipe being situated near the heating element.

2. The fluid reservoir according to claim 1, wherein the electric heating element is placed at a bottom of the bowl.

3. The fluid reservoir according to claim 2, wherein a temperature sensor, having a function for controlling the heating and thermal protection, is coupled to the heating element, this temperature sensor therefore also being located in the bottom region of the bowl.

4. The fluid reservoir according to claim 1, wherein the valve is a membrane valve.

5. The fluid reservoir according to claim 1, wherein the valve is placed in a bottom of the bowl.

6. The fluid reservoir according to claim 1, wherein a tube is provided submerged in the cavity delimited by the bowl and conveying electric power supply leads of the heating element.

7. The fluid reservoir according to claim 1, wherein the bowl is made of stainless steel.

8. The fluid reservoir according to claim 6, wherein the suction pipe for the fluid such as a reducing agent and the tube for conveying the electric power supply leads of the heating element are made of stainless steel.

9. The fluid reservoir according to claim 7, wherein the suction pipe for the fluid such as a reducing agent and the tube for conveying the electric power supply leads of the heating element are made of stainless steel.
